(19) United States
(12) Patent Application Publication
(10) Pub. No.: US 2002/0125120 A1
(43) Pub. Date: Sep. 12, 2002

(54) Tactile switch

(75) Inventor: Isao Miyashita, Yamanashi-ken (JP)

Correspondence Address: Ira J. Schultz, DENNISON, SCHEINER & SCHULTZ, Suite 612, 1745 Jefferson Davis Highway, Arlington, VA, 22202, US

(73) Assignee: Citizen Electronics Co., Ltd.

(21) Appl. No.: 10/073,009

(22) Filed: Feb. 12, 2002

(30) Foreign Application Priority Data
Mar. 6, 2001 (JP) 2001-062715

(51) Int. Cl. H01H 5/18

(52) U.S. Cl. 200/406

(57) ABSTRACT

A peripheral fixed contact having a circular hole is secured to a substrate, and a central fixed contact having a hole at a central portion thereof is secured to the substrate within the circular hole of the peripheral fixed contact. A spherical spring contact is mounted on the peripheral fixed contact so as to contact with an edge of the hole of the central fixed contact.

### BACKGROUND OF THE INVENTION

The present invention relates to a tactile switch used in a portable telephone, portable radio receiver, camera and others.

FIG. 6 is a plan view showing a conventional tactile switch, FIG. 7 is a sectional view taken along a line VII-VII of FIG. 6, FIG. 8 is a plan view showing another conventional tactile switch and FIG. 9 is a sectional view taken along a line IX-IX of FIG. 8.

The tactile switch has a side of 4 mm and a thickness of 0.5 mm. The switch has a substrate 1, a peripheral fixed contact 5 printed on the substrate 1 and having a circular hole 5a at a central portion thereof, a central fixed contact 6, printed on the substrate 1 in the circular hole 5a, a spherical spring contact 4 mounted on the peripheral fixed contact 5 and a flexible cover 21 made of plastic and adhered to the peripheral fixed contact 5 so as to press the spring contact 4 against the peripheral fixed contact.

Each of four corners of the substrate has a semicircular recess. Four terminal electrodes 9a to 9d are secured to the semicircular recesses and to the underside of the substrate 1 in order to connect the tactile switch with an instrument to be mounted therein.

The peripheral fixed contact 5 is connected to the terminal electrode 9a.

The central fixed contact 6 is connected to the terminal electrode 9c by a lead provided in a through-hole 7 and a conductive pattern 8.

The spring contact 4 is depressed through the cover 21 by a push button provided in the instrument, so that a central portion of the spring contact 4 is downwardly bent. The spring contact contacts with the central fixed contact 6, so that the peripheral fixed contact 5 is connected to the central fixed contact 6.

The switch shown in FIGS. 8 and 9 comprises a plurality of fixed contacts 5, 6 shown in FIGS. 6 and 7, provided on a substrate 22, a plurality of spring plates 4 and a cover 23 adhered to the substrate 22.

In the conventional switch, the cover 21 (23) contacts with the spring contact 4 at the entire surface of the spring contact 4.

Therefore, the contact area of the spring plate 4 with the central fixed contact is comparatively large. As a result, the contact pressure of the spring plate on the central fixed contact is low, which causes the reliability of the switch to decrease.

### SUMMARY OF THE INVENTION

An object of the present invention is to provide a tactile switch in which the spring contact contacts with the central fixed contact at a high pressure, thereby increasing the reliability of the switch.

According to the present invention, there is provided a tactile switch comprising a substrate, a peripheral fixed contact having a circular hole and secured to the substrate, a central fixed contact having a hole at a central portion thereof and secured to the substrate within the circular hole of the peripheral fixed contact, a spherical spring contact mounted on the peripheral fixed contact so as to contact with an edge of the hole of the central fixed contact.

The hole of the central fixed contact has inward projection.

The tactile switch further comprises an annular spacer made of insulation material and secured to the substrate, and a flexible cover secured to the spacer, the spring contact being provided within the spacer.

The tactile switch further comprises marks provided on an upper surface and on underside of the switch for detecting the upper surface.

These and other objects and features of the present invention will become more apparent from the following detailed description with reference to the accompanying drawings.

### BRIEF DESCRIPTION OF DRAWINGS

FIG. 1 is a plan view of a tactile switch of the present invention;

FIG. 2 is a sectional view taken along a line II-II of FIG. 1;

FIG. 3 is a bottom view of the tactile switch;

FIG. 4 is a plan view for showing a peripheral fixed contact and a central fixed contact;

FIG. 5 is a sectional view showing the operation of the switch;

FIG. 6 is a plan view showing a conventional tactile switch;

FIG. 7 is a sectional view taken along a line VII-VII of FIG. 6;

FIG. 8 is a plan view showing another conventional tactile switch; and

FIG. 9 is a sectional view taken along a line IX-IX of FIG. 8.

### DETAILED DESCRIPTION OF THE PREFERRED EMBODIMENT

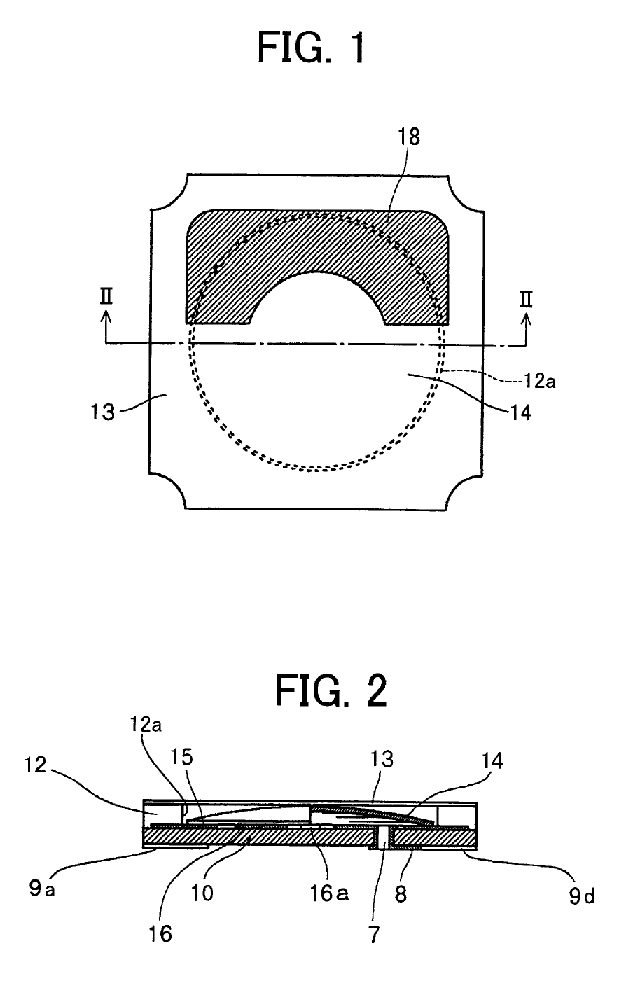

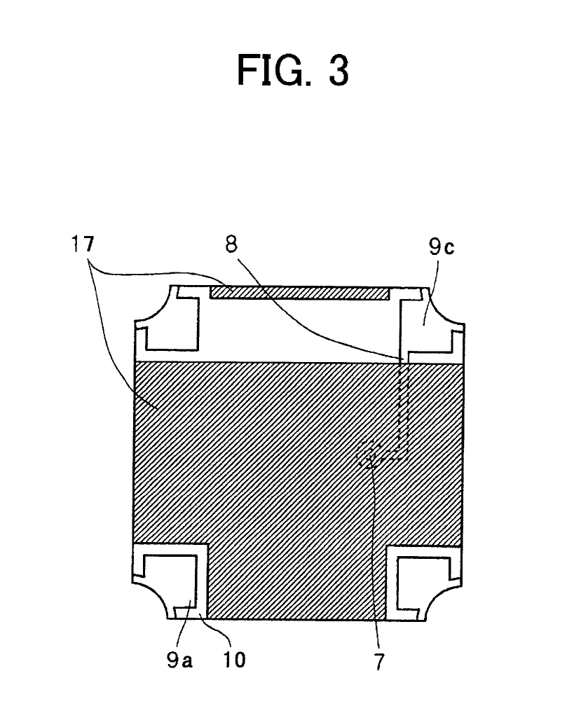

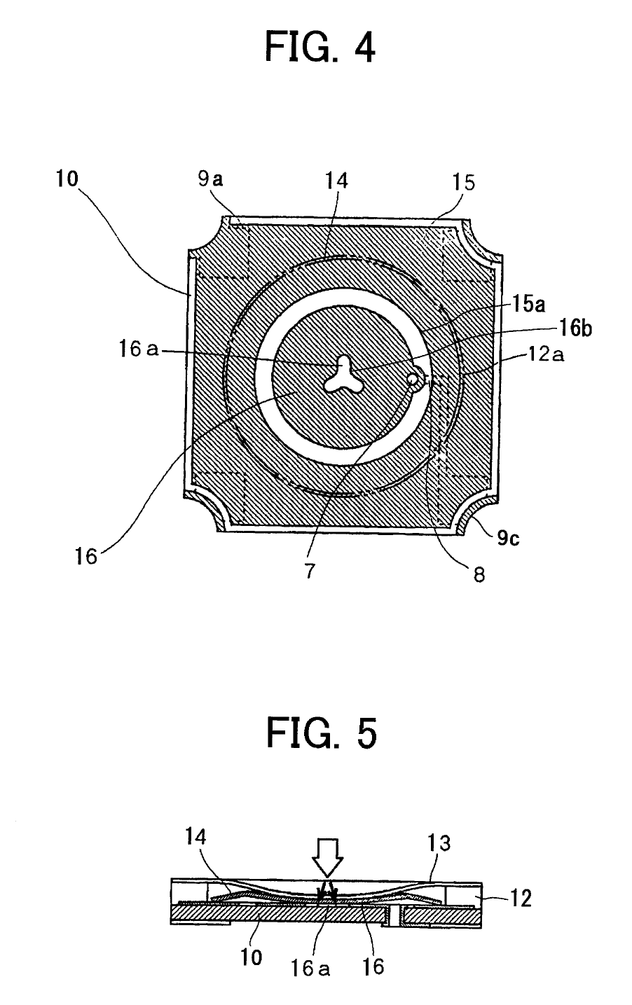

Referring to FIGS. 1, 2 and 4, the tactile switch has a substrate 10, a peripheral fixed contact 15 having a circular hole 15a and secured to the substrate 10, a central contact 16 secured to the substrate 10 at a central portion of the substrate 10 within the hole of the peripheral fixed contact, a spring contact 14 mounted on the peripheral fixed contact 15.

An annular spacer 12 made of insulation material such as polyimide and having a circular hole 12a is adhered to the peripheral fixed contact and to the substrate 10. The spacer 12 has a thickness larger than the height of the spring contact 14 and the diameter of the hole 12a is larger than that of the spring contact. A flexible cover 13 made of plastic is adhered to the spacer 12 so as to provide a watertight sealing. Thus, the spring contact 14 is surrounded by the spacer 12 and the cover 13.

In accordance with the present invention, a hole 16a having inward projections 16b is formed in the central fixed contact 16. Although the hole 16a has an inverted Y-shape, another shape such as a star shape, cross shape, circular shape, and others can be used.

Referring to FIGS. 1 and 3, an identification mark 18 having a color of white or green or black is printed on the cover 13, and identification marks 17 of white are printed on the underside of the substrate 10. The marks 18 and 17 are provided for identifying the upper surface and the position of the switch.

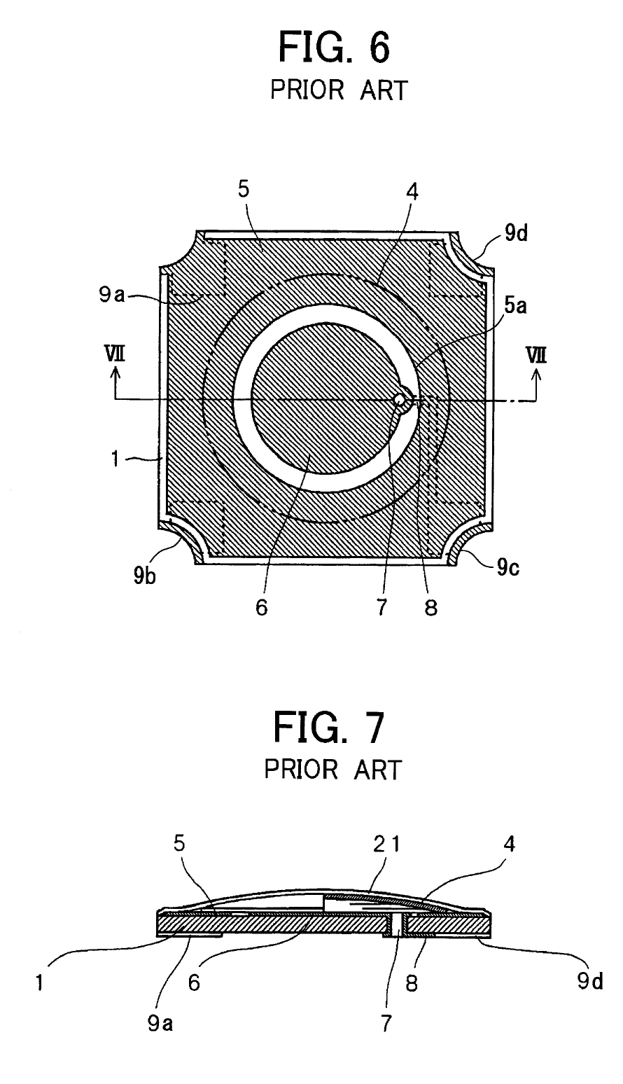

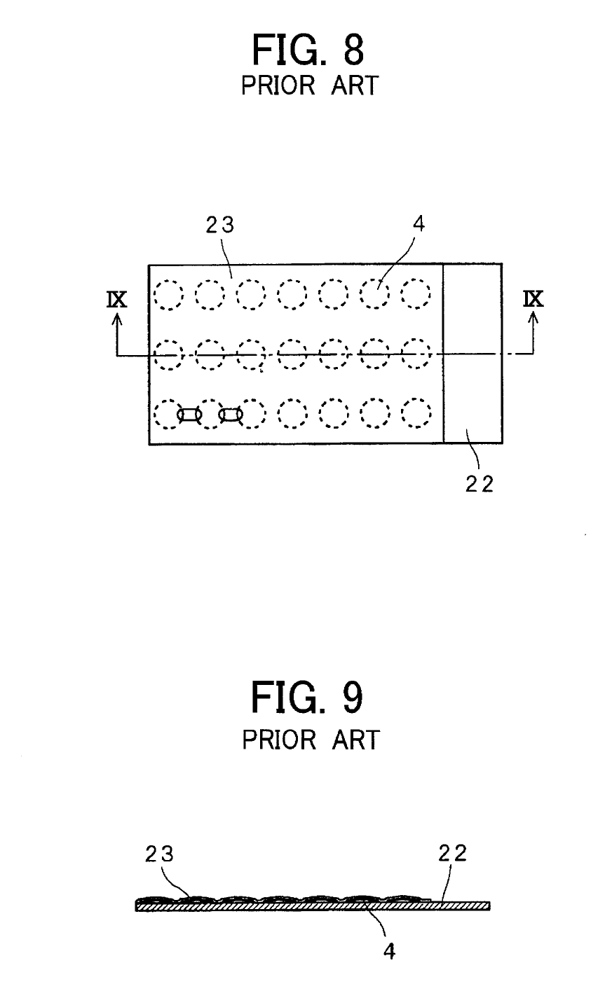

Other parts are the same as the conventional switch in construction, and the same numeral references as FIGS. 6 and 7 are used for identifying, and the explanation thereof is omitted.

When the cover 13 is depressed, a central portion of the spring contact 14 is downwardly bent. When the central portion of the spring contact 14 passes a neutral point, the spring contact is quickly inverted. Thus, the spring contact 14 contacts with the central fixed contact 16 as shown in FIG. 5.

The spring contact 14 contacts with edges of projections 16a of the hole 16 as shown by arrows of FIG. 5. Therefore, contact area of the spring contact 14 to the central fixed contact 16 is very small. Consequently, the contact pressure is very high compared with that of the conventional switch shown in FIGS. 6 and 7, so that the contact of the switch is reliably ensured. Further, dirt and oxidation film on the contacts 14 and 16 are removed by the high contact pressure, thereby keeping the contact surface clean.

In addition, since the height of the spherical top of the spring contact 14 becomes high due to the spacer 12, the top portion is largely inverted, and a peripheral portion of the spring contact does not contact with the cover 13 as shown in FIG. 5 so that the contact pressure further becomes high. Thus high reliability of the switch can be further ensured.

Furthermore, the upper surface and the position of the switch can be detected by optically detecting the identifying marks 18 and 17, so that the switch can be automatically set in an instrument by a setting machine.

While the invention has been described in conjunction with preferred specific embodiment thereof, it will be understood that this description is intended to illustrate and not limit the scope of the invention, which is defined by the following claims.

What is claimed is:

1. A tactile switch comprising:
a substrate;
a peripheral fixed contact having a circular hole and secured to the substrate;
a central fixed contact having a hole at a central portion thereof and secured to the substrate within the circular hole of the peripheral fixed contact;
a spherical spring contact mounted on the peripheral fixed contact so as to contact with an edge of the hole of the central fixed contact.

2. The tactile switch according to claim 1 wherein the hole of the central fixed contact has inward projection.

3. The tactile switch according to claim 1 further comprising an annular spacer made of insulation material and secured to the substrate, and a flexible cover secured to the spacer, the spring contact being provided within the spacer.

4. The tactile switch according to claim 1 further comprising marks provided on an upper surface and on underside of the switch for detecting the upper surface.
